(19) United States
(12) Patent Application Publication
(10) Pub. No.: US 2026/0063288 A1
(43) Pub. Date: Mar. 5, 2026

(54) INTELLIGENT FAN LAMP AND REMOTE CONTROL METHOD AND CONTROL SYSTEM BASED ON SIM CARD

(71) Applicant: Baiyao YAO, Cixi City (CN)

(72) Inventor: Baiyao YAO, Cixi City (CN)

(21) Appl. No.: 19/379,924

(22) Filed: Nov. 5, 2025

(51) Int. Cl. F21V 23/04; F04D 25/08; F21V 33/00; G10L 15/22; H04W 8/18

(52) U.S. Cl. CPC F21V 23/0435; F04D 25/088; F21V 33/0096; G10L 15/22; H04W 8/18; G10L 2015/223; G10L 2015/225

(57) ABSTRACT

An intelligent fan lamp and a remote control method and control system based on a SIM card, including a base, fan blades, and a drive motor. A fixed seat is connected to the bottom of the base and located below the fan blades. A voice interaction device configured for voice interaction and a control module electrically connected to the drive motor and the voice interaction device are provided on the fixed seat. The control module includes a SIM card slot and a card slot provided on the SIM card slot. A light strip electrically connected to the control module and a lampshade configured to cover the light strip are provided on the fixed seat. By inserting a SIM card into the card slot, the fan lamp gains independent mobile communication capability, enabling remote control in environments without Wi-Fi networks, thereby expanding its application scenarios.

### TECHNICAL FIELD

The present disclosure relates to the technical field of fan lamps, and particularly to an intelligent fan lamp and a remote control method and control system based on a subscriber identity module (SIM) card.

### BACKGROUND

Conventional fan lamps typically only possess basic fan rotation functions, with control methods mostly limited to mechanical switches or infrared remote control, resulting in deficiencies such as limited interaction methods and inability to achieve remote control. In scenarios with poor network coverage or no network availability, conventional ceiling fans face difficulties in achieving intelligent control, failing to meet users' needs for remote operation and intelligent interaction with devices. Furthermore, existing ceiling fans have relatively singular functions, only capable of providing illumination and fan rotation, which is unable to satisfy users' demands for intelligent and interactive home devices.

### SUMMARY

In view of the above, the present disclosure provides a fan lamp integrating voice interaction and network communication functions, and a remote control method and control system based on a subscriber identity module (SIM) card.

The present disclosure provides an intelligent fan lamp, including a base configured to be mounted on a wall, fan blades arranged at a bottom of the base, and a drive motor arranged in the base and configured to drive the fan blades to rotate, and a fixed seat connected to a bottom of the base and located below the fan blades. The fixed seat is provided with a voice interaction device configured for voice interaction, a control module electrically connected to the drive motor and the voice interaction device, a light strip electrically connected to the control module, and a lampshade configured to cover the light strip. The control module includes a subscriber identity module (SIM)card slot and a card slot provided on the SIM card slot, the card slot is configured to insert a subscriber identity module (SIM) card for network connection.

In some implementations of the present disclosure, the voice interaction device includes a housing provided on the fixed seat, a microphone arranged in the housing and configured to receive voice commands, and a speaker arranged in the housing and configured to output voice commands; the housing includes a main body fixed to the fixed seat and a cover detachably assembled at a bottom of the main body; a plurality of first through holes communicating with the microphone and a plurality of second through holes communicating with the speaker are provided on the cover.

In some implementations of the present disclosure, the voice interaction device is arranged at a center of the fixed seat, the light strip is in an annular shape, and the light strip is arranged surrounding the voice interaction device; an opening is provided on the lampshade for the voice interaction device to pass through, and the lampshade is connected to the fixed seat by threaded connection.

In some implementations of the present disclosure, the drive motor includes a motor shaft fixed to the base by threaded connection, and a rotor portion rotatably arranged on the motor shaft, where the fan blades are fixed to the rotor portion; a lower end of the motor shaft extends beyond the bottom of the base, a connecting plate is sleeved on the lower end of the motor shaft, a locking nut configured to lock and fix the connecting plate is provided on the lower end of the motor shaft, and the fixed seat is fixed to the connecting plate.

In some implementations of the present disclosure, the control module includes a circuit board arranged in the housing, and a control chip arranged on the circuit board, where the SIM card slot is arranged on the circuit board.

In some implementations of the present disclosure, the intelligent fan lamp further includes:
a remote communication module, configured to receive input information from the control module, where the remote communication module integrates blockchain node functionality and is configured to encrypt user voice commands and transmit the input information to an Artificial Intelligence (AI) large model system through a wireless network; the AI large model system includes distributed Artificial Intelligence (AI) nodes, where each node collaboratively processes voice commands through smart contracts and generates return results; the return results include lamp control commands and intelligent service recommendations related to user context;
the control module is provided with an edge computing unit configured to perform lightweight semantic parsing locally and dynamically allocate tasks with the distributed AI nodes.

In some implementations of the present disclosure, the control module further includes a prompt word rule database, and is further configured to pre-obtain prompt word rules of the AI large model system, determine whether modification of input information is required based on the prompt word rules, and modify the input information based on the prompt word rules to generate modified input information when the control module determines that modification of the input information is required;
the prompt word rule database includes context-aware templates and user behavior profiles, and the control module generates modified input information through the following methods:
(a) extracting spatiotemporal characteristic parameters from voice commands, including present time, ambient light intensity, and mechanical structure position status;
(b) calculating context weight coefficients in combination with user historical operation records;
(c) matching an optimal prompt word framework from a template library according to the weight coefficients; and
(d) embedding original voice commands into the framework to generate structured query statements;
where the distributed AI nodes invoke a multimodal large model to generate responses according to the structured query statements.

In some implementations of the present disclosure, the control module is further configured to determine whether explanatory information is required to be added to return results after obtaining the return results from the AI large model system, generate explanatory information by invoking an explanatory information generation module based on preset preference information of lamp users after determining that explanatory information is required to be added to the return results, and add the explanatory information to the return results to generate modified return results;
the explanatory information generation module includes: a credibility assessment unit, configured to calculate confidence scores based on feature vectors of return results from the AI large model system; and
a personalized adaptation unit, configured to invoke a user preference model in a storage module, where the user preference model is continuously updated through federated learning; when the confidence score is lower than a threshold, the personalized adaptation unit automatically appends alternative solution descriptions and verification requests;
the explanatory information is output in the form of interactive voice segments, supporting users to provide feedback and corrections through natural language.

In some implementations of the present disclosure, the lamp further includes a storage module configured to store user preference information;
the storage module includes:
a privacy protection partition, configured to store user biometric data using homomorphic encryption technology;
an interactive memory unit, configured to record a triplet relationship graph of device status-voice command-user feedback; and
a model cache area, configured to store lightweight inference models delivered by the AI large model system, supporting maintenance of basic intelligent services during network interruption,
the control module automatically optimizes a local decision tree based on data from the memory unit to achieve intention prediction in an offline state.

The present disclosure further provides a method for remote control of a fan lamp based on a SIM card, applied to the fan lamp, including:
initializing a SIM card communication unit through a preset information processing unit, and connecting cellular network registration with a server;
receiving remote control instructions through the SIM card communication unit, and transmitting the remote control instructions to the information processing unit for parsing;
executing received remote control instructions based on the information processing unit, and uploading device operating status through the cellular network;
the initializing the SIM card communication unit includes integrating an embedded microcontroller into a drive module, connecting to the SIM card communication unit through UART (Universal Asynchronous Receiver Transmitter), where the communication unit includes an FPC (flexible printed circuit) antenna and power management, the embedded microcontroller is configured with a serial port buffer and an exception interrupt mechanism to construct a complete device initialization and communication infrastructure;
the receiving remote control instructions through the SIM card communication unit includes transmitting the remote control instructions encapsulated by the server to the SIM card communication unit, and outputting the remote control instructions by the SIM card communication unit to the information processing unit through a serial port;
the uploading device operating status through the cellular network includes periodically reading the cache by the information processing unit and uploading the status through the SIM card communication unit, and interrupting the process to construct and send a marked status frame when the status is abnormal.

In some implementations of the present disclosure, the initializing the SIM card communication unit includes:
employing an embedded microcontroller as a core control chip by the information processing unit after the fan lamp is powered on and started upon connection to a power supply; integrating the microcontroller inside a ceiling lamp power drive module; connecting to the SIM card communication unit through a standard UART interface, where the SIM card communication unit includes a SIM card slot, a power management unit, and a radio frequency antenna interface; encapsulating the SIM card communication unit on a communication area of a circuit board; leading out antenna layout to an edge of a plastic lamp cover through a flexible printed circuit (FPC) board; connecting LED light-emitting units to the embedded microcontroller through Pulse Width Modulation (PWM) control lines and switch signal lines; positioning an LED drive circuit on a main control power module; establishing communication connection between the LED drive circuit and the embedded MCU (Microcontroller Unit) in the information processing unit through a bus; arranging the LED drive circuit in a middle portion of the lamp body; providing power supply between various components by a unified Direct Current (DC) power source; distributing power through motherboard power cables; supporting input voltage detection; connecting the voltage detection to an Analog-to-Digital Conversion (ADC) interface of the embedded microcontroller; configuring a serial port buffer management mechanism in firmware of the embedded microcontroller; handling transceiving processes of serial port input data frames and output status frames; and setting an exception flag to trigger emergency communication path interruption and status retransmission.

In some implementations of the present disclosure, the connecting cellular network registration with a server includes:
accessing a network through a built-in radio frequency device by the SIM card communication unit automatically; maintaining a communication heartbeat connection with the server;
searching for and accessing a network automatically after the cellular unit completes SIM card activation; performing frequency scanning by an internal scheduling mechanism of the cellular unit according to a preset priority operator frequency band table in memory; selecting a base station with optimal signal quality for access; completing an Attach process;
configuring an IP address based on PDP (Packet Data Protocol) context activation after successful network registration; initiating a TCP (Transmission Control Protocol) connection with a designated server through an AT+CIPSTART command driven by instructions from the embedded microcontroller; setting a heartbeat packet transmission interval threshold after successful connection; returning an ACK (Acknowledge character) response packet by the server upon receiving the heartbeat packet; confirming effective communication;
entering a disconnection reconnection state by the embedded microcontroller automatically if no heartbeat response is received within a set transmission count threshold; and recording the reason for disconnection.

In some implementations of the present disclosure, the receiving remote control instructions through the SIM card communication unit includes:
initiating, by terminal users, lighting control commands through an APP (Application) platform and uploading the lighting control commands to a server; forwarding, by the server, the lighting control commands to the SIM card communication unit through the cellular network; initiating control commands in the interface includes turning lights on/off, dimming, timing, and status query;
encapsulating the control commands in JSON (JavaScript Object Notation) format and uploading the control commands to a cloud server API (Application Programming Interface) interface through the HTTPS (HyperText Transfer Protocol Secure) protocol; performing identity authentication and data parsing by the server; delivering the control commands to the IP address and port of the SIM card communication unit bound to the corresponding device through a Socket connection;
monitoring server data by the SIM card communication unit continuously while maintaining a TCP connection state; outputting complete control instructions to the information processing unit through a serial port after receiving control data frames;
performing logical verification on the complete control instructions by the information processing unit; triggering corresponding control processes including turning on LEDs and adjusting PWM signals.

In some implementations of the present disclosure, the parsing includes:
outputting complete data frames received from the server to a UART interface of a main control embedded microcontroller by the SIM card communication unit; reading the serial port buffer in real time by a serial port monitoring program running in the embedded microcontroller; parsing frame headers, frame bodies, and check bits according to a control protocol structure; forming control protocol frames of fixed-length or variable-length formats including frame headers, command identifiers, payloads, and check codes; determining by the embedded microcontroller that the command identifier field is LAMP_CTRL and the payload field is an ON or OFF command; performing check code verification; invoking lighting control function interfaces according to corresponding control logic processes after successful verification; recording an exception log and ignoring the present command by the embedded microcontroller if check code verification fails or the command is illegal.

In some implementations of the present disclosure, the executing received remote control instructions based on the information processing unit includes:
executing control commands by the embedded microcontroller invoking a driver layer interface according to command content to control an LED status, where the LED status includes setting GPIO (General Purpose Input Output) high and low levels to control switching, and adjusting brightness levels through a PWM unit;
invoking a sensor module interface by the embedded microcontroller to read lamp operating status information, where the lamp operating status information includes a present brightness level, a current value, a voltage value, and an operating mode; constructing a status data packet; caching the constructed status data packet in a communication buffer for uploading;
generating a status code and encapsulating the status code into a status response frame by the embedded microcontroller if command execution fails or feedback is abnormal.

In some implementations of the present disclosure, the uploading device operating status through the cellular network includes:
setting a status data upload period by the information processing unit; invoking a communication interface by a timed task to read a latest constructed status packet from a status cache queue; formatting the status packet into a JSON string; sending an AT+CIPSEND command to the SIM card communication unit to initiate a TCP data transmission process; waiting for the server to return an ACK (Acknowledge character) response packet by the SIM card communication unit after transmission completion; confirming successful reception; pushing present data back into a transmission queue by the embedded microcontroller if no response is received within a set time threshold; initiating a backoff retransmission mechanism; setting an exception priority upload mechanism; interrupting periodic upload tasks immediately when detecting voltage abnormality or current mutation; sending an emergency status frame forcibly; and marking the frame with an urgent field for prioritized processing by the server.

The present disclosure further provides a remote control system for a fan lamp based on a SIM card, including a communication initialization module, an instruction receiving module, and a status reporting module;
the communication initialization module includes a main control initialization module and a network access module, where the main control initialization module is configured to automatically initialize the SIM card communication unit through the information processing unit after the fan lamp is powered on, send AT commands to complete module activation and network configuration, and establish an initial connection with a server; the network access module is configured to automatically complete base station access, IP configuration, and TCP link establishment through the SIM card communication unit, and confirm stable connection with a cloud server by periodically sending heartbeat packets;
the instruction receiving module includes a remote instruction module and a protocol parsing module, where the remote instruction module is configured to receive control instructions issued by users through an APP and forwarded by the server through the SIM card communication unit, and transmit the control instructions to the information processing unit via a serial port for executing lamp control; the protocol parsing module is configured to perform structured parsing of received data frames through the information processing unit, identify command types, perform check code verification to determine legality, and execute control logic;
the status reporting module includes a control execution module and a status processing module, where the control execution module is configured to drive an LED unit to respond to control instructions based on parsing results through the information processing unit, and collect present device operating status for reporting to the server; the status processing module is configured to upload device status data to the cloud through the SIM card communication unit periodically or upon abnormal triggers, and process ACK responses or retransmission mechanisms.

The beneficial effects of the present disclosure are: By inserting a SIM card into the SIM card slot, the fan lamp gains independent mobile communication capability, enabling remote control in environments without Wi-Fi networks, thereby expanding its application scenarios. Furthermore, by providing the voice interaction device, natural human-machine interaction is achieved, improving user convenience. Additionally, by establishing a cellular module to implement a communication link between two fan lamps, users' demands for intelligent and interactive home devices may be satisfied.

### BRIEF DESCRIPTION OF THE DRAWINGS

FIG. 1 is an exploded schematic view of the fan lamp of the present disclosure;

FIG. 2 is a schematic view of the fan lamp of the present disclosure;

FIG. 3 is an exploded schematic view of the voice interaction device in the fan lamp of the present disclosure;

FIG. 4 is an overall flowchart of the remote control method for the fan lamp based on a SIM card according to the present disclosure;

FIG. 5 is an overall flowchart of the remote control system for the fan lamp based on a SIM card according to the present disclosure.

### DETAILED DESCRIPTION

Hereinafter, exemplary embodiments according to the present disclosure are described in detail with reference to the accompanying drawings. It is apparent that the described embodiments are merely part of the embodiments of the present disclosure, rather than all of the embodiments. It should be understood that the present disclosure is not limited to the exemplary embodiments described herein.

It should be noted that unless otherwise specifically stated, the relative arrangement of components and steps, numerical expressions, and numerical values set forth in these embodiments are not intended to limit the scope of the present disclosure.

Regarding any component, data, or structure mentioned in the embodiments of the present disclosure, unless explicitly defined or contrary indications are provided in the context, it should generally be understood as one or more.

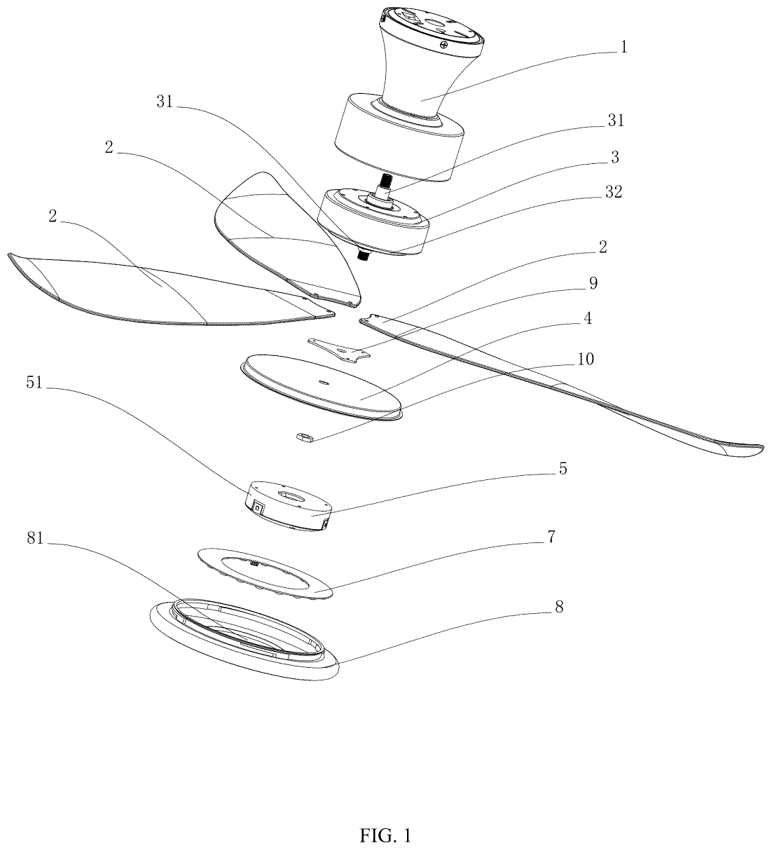

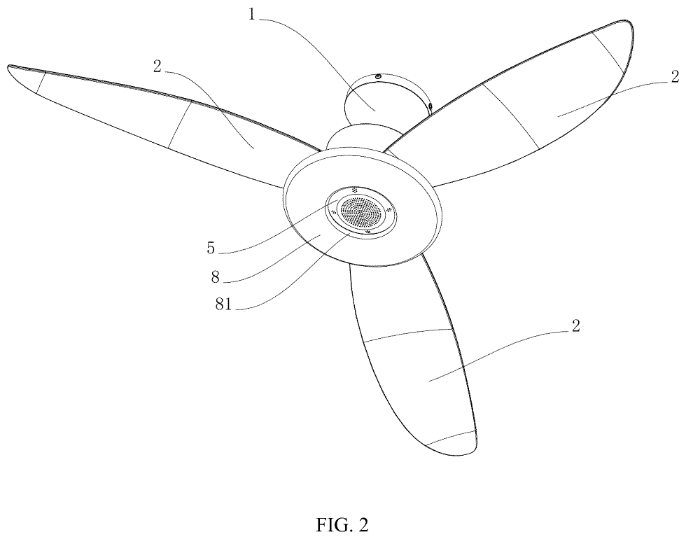

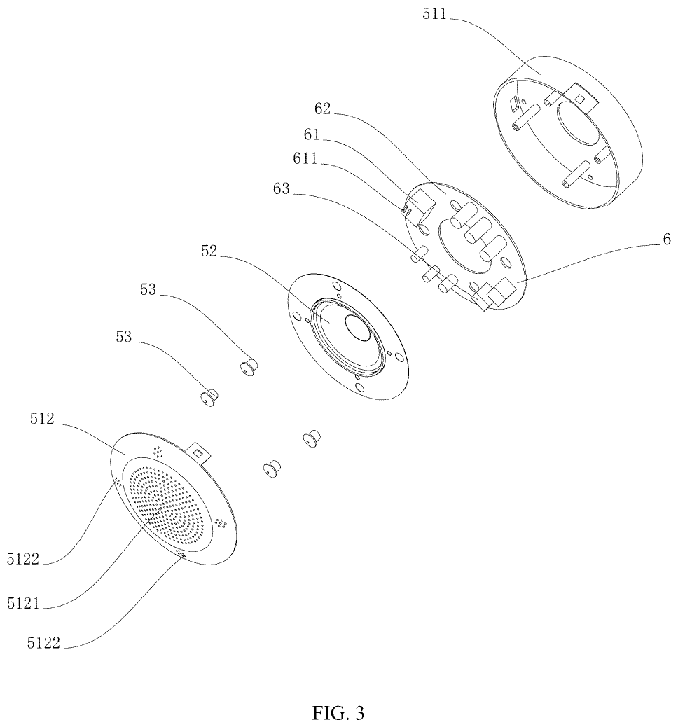

Hereinafter, the technical solutions in the embodiments of the present disclosure are clearly and completely described in combination with the accompanying drawings. With reference to FIGS. 1 to 3, an intelligent fan lamp includes a base 1 configured to be mounted on a wall, fan blades 2 arranged at a bottom of the base 1, and a drive motor 3 arranged in the base 1 and configured to drive the fan blades 2 to rotate. A fixed seat 4 is connected to the bottom of the base 1 and located below the fan blades 2. A voice interaction device 5 configured for voice interaction and a control module 6 electrically connected to the drive motor 3 and the voice interaction device 5 are provided on the fixed seat 4. The control module 6 includes a SIM card slot 61 and a card slot 611 provided on the SIM card slot 61 and configured to insert a SIM card for network connection. A light strip 7 electrically connected to the control module 6 and a lampshade 8 configured to cover the light strip 7 are provided on the fixed seat 4. By inserting a SIM card into the card slot 611 of the SIM card slot 61, the fan lamp gains independent mobile communication capability, enabling remote control in environments without Wi-Fi networks and significantly expanding its application scenarios. Furthermore, by providing the voice interaction device 5, natural human-machine interaction is achieved, improving user convenience.

In the present disclosure, the voice interaction device 5 includes a housing 51 provided on the fixed seat 4, a microphone 52 arranged in the housing 51 and configured to receive voice commands, and a speaker 53 arranged in the housing 51 and configured to output voice commands. The control module 6 is arranged in the housing 51. Through the arrangement of the voice interaction device 5, users may interact with the ceiling fan using natural language without manually operating switches or remote controls, thereby improving convenience of use. Specifically, the housing 51 of the voice interaction device 5 is embedded in the fixed seat 4. The microphone 52 is an electret microphone with a sensitivity of −38 dB, effectively capturing voice commands within a range of 5 meters. The speaker 53 is a small-sized 2 W/8Ω speaker with clear sound quality.

In the present disclosure, the housing 51 includes a main body 511 fixed to the fixed seat 4 and a cover 512 detachably assembled at a bottom of the main body 511. Specifically, the cover 512 and the main body 511 are detachably connected through a snap-fit structure, allowing the cover 512 to be removed from the main body 511 for SIM card replacement. Furthermore, a plurality of first through holes 5121 communicating with the microphone 52 and a plurality of second through holes 5122 communicating with the speaker 53 are provided on the cover 512. The arrangement of the first through holes 5121 and the second through holes 5122 on the cover 512 ensures smooth transmission of sound signals, reducing sound attenuation and distortion.

In the present disclosure, the voice interaction device 5 is arranged at a center of the fixed seat 4. The light strip 7 has an annular shape and is arranged surrounding the voice interaction device 5, achieving rational spatial layout and utilization while separating the light strip 7 to prevent high temperatures generated during its illumination from affecting other components.

In the present disclosure, an opening 81 through which the voice interaction device 5 passes is provided on the lampshade 8. The lampshade 8 is connected to the fixed seat 4 by means of threaded connection. Specifically, the lampshade 8 and the fixed seat 4 are detachably connected through a threaded engaging structure, allowing the lampshade 8 to be removed from the fixed seat 4 for replacement of the light strip 7 and for detaching the cover 512 from the main body 511 to replace the SIM card.

In the present disclosure, the drive motor 3 includes a motor shaft 31 fixed to the base 1 by means of threaded connection and a rotor portion 32 rotatably arranged on the motor shaft 31. The fan blades 2 are fixed to the rotor portion 32. Specifically, an upper end of the motor shaft 31 is fixed to the base 1 through a threaded shaft. Furthermore, a lower end of the motor shaft 31 extends beyond a bottom of the base 1. A connecting plate 9 is sleeved on the lower end of the motor shaft 31. The fixed seat 4 is fixed to the connecting plate 9. A locking nut 10 configured to lock and fix the connecting plate 9 is provided on the lower end of the motor shaft 31 and located below the fixed seat 4. Specifically, the locking nut 10 is screwed onto a threaded shaft at the lower end of the motor shaft 31.

In the present disclosure, the control module 6 includes a circuit board 62 arranged in the housing 51 and a control chip 63 arranged on the circuit board 62. The SIM card slot 61 is arranged on the circuit board 62. Specifically, the control module 6 is a printed circuit board integrating an STM32F103RCT6 microcontroller, a 4G cellular module (such as Quectel BC660K), a power management chip, and other components. The SIM card slot is a standard Nano SIM card slot capable of accepting carrier SIM cards. The control chip 63 is an XK3031TW chip. The XK3031TW chip incorporates a three-phase MOS driver module, adjusts light source brightness through PWM signals, and monitors present current and voltage parameters in real time through an ADC interface.

In the present disclosure, the fan lamp further includes a remote communication module, configured to receive input information from the control module, where the remote communication module integrates blockchain node functionality and is configured to encrypt user voice commands and transmit the input information to an AI large model system through a wireless network; the AI large model system includes distributed AI nodes, where each node collaboratively processes voice commands through smart contracts and generates return results; the return results include lamp control commands and intelligent service recommendations related to user context;
the control module is provided with an edge computing unit configured to perform lightweight semantic parsing locally and dynamically allocate tasks with the distributed AI nodes.

The control module is further configured to output the return results.

In the present disclosure, the control module further includes a prompt word rule database, and is further configured to pre-obtain prompt word rules of the AI large model system, determine whether modification of input information is required based on the prompt word rules, and modify the input information based on the prompt word rules to generate modified input information when it is determined that modification of the input information is required;
the prompt word rule database includes context-aware templates and user behavior profiles, and the control module generates modified input information through the following methods:
(a) extracting spatiotemporal characteristic parameters from voice commands, including present time, ambient light intensity, and mechanical structure position status;
(b) calculating context weight coefficients in combination with user historical operation records;
(c) matching an optimal prompt word framework from a template library according to the weight coefficients; and
(d) embedding original voice commands into the framework to generate structured query statements;
where the distributed AI nodes invoke a multimodal large model to generate responses according to the structured query statements.

In the present disclosure, the control module is further configured to determine whether explanatory information is required to be added to return results after obtaining the return results from the AI large model system, generate explanatory information by invoking an explanatory information generation module based on preset preference information of lamp users after determining that explanatory information is required to be added to the return results, and add the explanatory information to the return results to generate modified return results;
the explanatory information generation module includes: a credibility assessment unit, configured to calculate confidence scores based on feature vectors of return results from the AI large model system; and
a personalized adaptation unit, configured to invoke a user preference model in a storage module, where the user preference model is continuously updated through federated learning; when the confidence score is lower than a threshold, automatically appends alternative solution descriptions and verification requests;
where the explanatory information is output in the form of interactive voice segments, supporting users to provide feedback and corrections through natural language.

In the present disclosure, the lamp further includes a storage module configured to store user preference information;
the storage module includes:
a privacy protection partition, configured to store user biometric data using homomorphic encryption technology;
an interactive memory unit, configured to record a triplet relationship graph of device status-voice command-user feedback; and
a model cache area, configured to store lightweight inference models delivered by the AI large model system, supporting maintenance of basic intelligent services during network interruption,
where the control module automatically optimizes a local decision tree based on data from the memory unit to achieve intention prediction in an offline state.

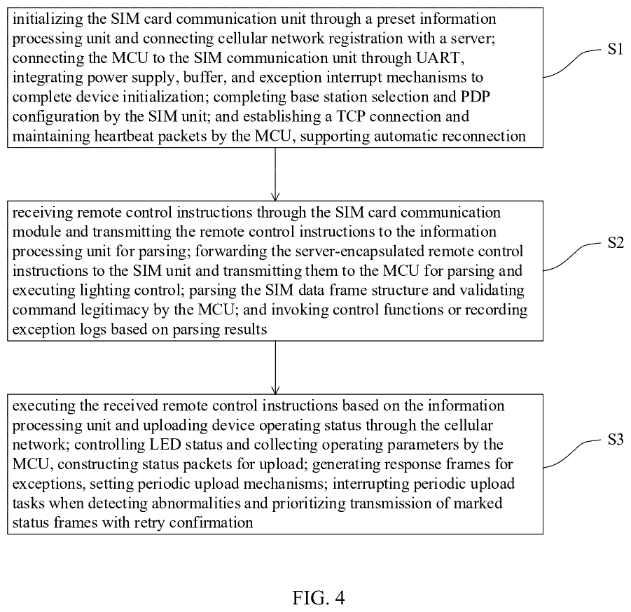

With reference to FIG. 4, disclosed in the present disclosure is further a remote control method for a fan lamp based on a SIM card, where a communication module is described by taking a SIM card as an example. However, it should be understood by those skilled in the art that various suitable types of communication modules may be used. For example, the SIM card may be of various sizes or types, such as a SIM card, a mini SIM card, or a Nano SIM card. Furthermore, the communication module may also be an eSIM card. Specifically, a 5G super SIM card may cooperate with an App to achieve one-click backup and one-click restoration of core data between different mobile phones, making it easy to change mobile phones with one card. An eSIM transforms a traditional SIM card into an “electronic version” embedded directly into the device chip, eliminating the need for users to insert a physical SIM card while providing equivalent functionality.

In the present disclosure, a typical wireless communication system may employ multiple access technologies capable of supporting communication with multiple users by sharing available system resources. Examples of such multiple access technologies include code division multiple access (CDMA) systems, time division multiple access (TDMA) systems, frequency division multiple access (FDMA) systems, orthogonal frequency division multiple access (OFDMA) systems, single-carrier frequency division multiple access (SC-FDMA) systems, and time division synchronous code division multiple access (TD-SCDMA) systems. These multiple access technologies have been adopted in various telecommunications standards.

In the present disclosure, cellular networks include 4G, 5G, and subsequent evolved versions.

The remote control method for a fan lamp includes:

S1: initializing a SIM card communication unit through a preset information processing unit, and connecting cellular network registration with a server.

Further, the initializing a SIM card communication unit includes: after the fan lamp completes power-on startup upon connecting to a power supply, the information processing unit adopts an embedded microcontroller (Microcontroller Unit, MCU) as the core control chip, which is integrated inside the ceiling lamp power drive module and connected to the SIM card communication unit through a standard Universal Asynchronous Receiver/Transmitter (UART) interface. The SIM card communication unit includes a SIM card slot, a power management unit, and a radio frequency antenna interface. The SIM card communication unit is encapsulated on the communication area of the circuit board, and the antenna layout is led out to the edge of the plastic lamp cover through a flexible printed circuit board. The LED light-emitting units are connected to the embedded microcontroller through Pulse Width Modulation (PWM) control lines and switch signal lines. The LED drive circuit is located on the main control power module and establishes communication connection with the embedded microcontroller in the information processing unit through buses such as Controller Area Network (CAN), Universal Synchronous/Asynchronous Receiver/Transmitter (USART), Inter-Integrated Circuit (I2C), or Serial Peripheral Interface (SPI). It should be understood that the technical solution of the present disclosure is described by taking CAN, USART, I2C, and SPI as examples, and those skilled in the art may conceive of using any suitable data transmission protocols or buses. The LED drive circuit is arranged in the middle portion of the lamp body. Power supply between various components is provided by a unified DC power source and distributed through motherboard power cables, supporting input voltage detection and connection to the Analog-to-Digital Converter (ADC) interface of the embedded microcontroller. A serial port buffer management mechanism is configured in the firmware of the embedded microcontroller to handle the transceiving process of serial port input data frames and output status frames, and an exception flag is set to trigger emergency communication path interruption and status retransmission.

It should be noted that connecting cellular network registration with a server includes: the SIM card communication unit automatically accesses the network through a built-in radio frequency device and maintains a communication heartbeat connection with the server.

After the cellular unit completes SIM card activation, it automatically searches for and accesses the network. The internal scheduling mechanism of the cellular unit performs frequency scanning according to a preset priority operator frequency band table stored in memory, selects the base station with optimal signal quality for access, and completes the Attach process.

Upon successful network registration, an IP address is configured based on PDP (Packet Data Protocol) context activation. Driven by instructions from the embedded microcontroller, a TCP (Transmission Control Protocol) connection with the designated server is initiated through the AT+CIPSTART command. After successful connection, the heartbeat packet transmission interval is set to 30 seconds (format example: {“hb”:1}). The server returns an ACK (Acknowledge character) response packet upon receiving the heartbeat packet to confirm effective communication.

If no heartbeat response is received within 3 attempts, the embedded microcontroller automatically enters a disconnection reconnection state and records the reason for disconnection.

It should also be noted that initializing the SIM communication unit through the preset information processing unit and connecting cellular network registration with the server enables the autonomous communication capability establishment of the fan lamp device after power-on. The initialization process includes the startup of the embedded system on the main control chip (embedded microcontroller), configuration of the serial communication mechanism, loading of AT command sets to complete PIN verification and module reset, and execution of network standard selection, base station signal search, TCP/IP protocol stack activation, and handshake connection with the designated server by the SIM communication unit. A stable data interaction link is established between the embedded microcontroller and the communication unit through the UART serial port, and network status maintenance monitoring, connection failure determination, and reconnection strategy control are achieved through hardware-software collaboration. The physical structure integrates module layout design, such as slot-fixed SIM module, FPC antenna layout, power detection feedback channels, and communication fault interruption logic. It features plug-and-play capability, autonomous network registration, and rapid communication link establishment, thereby laying a highly stable and structurally adaptable foundation for subsequent remote control and data interaction. This achieves the prerequisite for independent operation and control of the device in environments without gateways or WiFi.

S2: receiving remote control instructions through the SIM card communication unit, and transmitting the remote control instructions to the information processing unit for parsing.

Furthermore, receiving remote control instructions through the SIM card communication unit includes the following: terminal users initiate lighting control commands through an APP platform and upload them to a server, which then forwards the commands to the SIM card communication unit via the cellular network. Control commands initiated in the interface include turning lights on/off, dimming, timing, and status query.

The control commands are encapsulated in JSON format and uploaded to a cloud server API interface through the HTTPS protocol. After identity authentication and data parsing by the server, the control commands are delivered to the IP address and port of the SIM card communication unit bound to the corresponding device through a Socket connection.

The SIM card communication unit continuously monitors server data while maintaining a TCP connection state and outputs complete control instructions to the information processing unit through a serial port upon receiving control data frames.
after performing logical verification on the complete control instructions, the information processing unit triggers corresponding control processes, including turning on LEDs and adjusting PWM signals.

It should be noted that the parsing includes the following: the SIM card communication unit outputs complete data frames received from the server to the UART interface of the main control embedded microcontroller. A serial port monitoring program running in the embedded microcontroller reads the serial port buffer in real time and parses the frame header, frame body, and check bits according to the control protocol structure. The control protocol frames consist of fixed-length or variable-length formats including a frame header, command identifier, payload, and check code. The transmission and parsing of control instructions in serial communication are performed. The embedded microcontroller determines that the command identifier field is LAMP_CTRL and the payload field is an ON or OFF instruction, and performs check code verification. After successful verification, the lighting control function interface is invoked according to the corresponding control logic flow. If the check code verification fails or the command is illegal, the embedded microcontroller records an exception log and ignores the current command.

It should further be noted that receiving remote control instructions through the SIM card communication unit and transmitting them to the information processing unit for parsing achieves the complete process of the fan lamp receiving precise control commands from the cloud system. Control commands generated through the APP platform are encapsulated in JSON format and uploaded to the cloud server via HTTPS. After identity verification and target device matching by the server, the commands are forwarded to the SIM module of the target device through a Socket connection. The communication module continuously monitors the server's downlink data channel while maintaining a TCP connection state. Upon receiving complete data frames, they are output to the information processing unit via the serial port. The information processing unit runs a monitoring program to parse the data frame structure and determine whether the command type field corresponds to lamp control operation instructions. This achieves closed-loop control of the data chain from remote user command initiation→server forwarding→device reception→command parsing, ensuring that control commands are accurately and securely delivered to the device's internal control core. It supports real-time control functions such as switching, dimming, and status query, and establishes a complete data entry mechanism for subsequent control execution and feedback response, achieving coordination and unification of command path security, communication link immediacy, and device entry standardization.

S3: executing received remote control instructions based on the information processing unit, and uploading device operating status through the cellular network.

Furthermore, executing the received remote control instructions based on the information processing unit includes the following: when executing control commands, the embedded microcontroller invokes driver layer interfaces according to the command content to control the LED status, including setting GPIO high and low levels to control switching and adjusting brightness levels through the PWM unit.

The embedded microcontroller invokes sensor module interfaces to read the lamp operating status information, including present brightness level, current value, voltage value, and operating mode, and constructs a status data packet. The constructed status data packet is cached in the communication buffer for uploading.
the embedded microcontroller simultaneously generates a status code and encapsulates the status code into a status response frame if command execution fails or feedback is abnormal.

It should be noted that uploading device operating status through the cellular network includes: the information processing unit sets a status data upload period, and a timed task invokes the communication interface to read the latest constructed status packet from the status cache queue and formats it into a JSON string. Then, an AT+CIPSEND command is sent to the SIM card communication unit to initiate the TCP data transmission process. After transmission is completed, the SIM card communication unit waits for the server to return an ACK response packet to confirm successful reception. If no response is received within 3 seconds, the MCU pushes the present data back into the transmission queue and initiates a backoff retransmission mechanism. An exception priority upload mechanism is set, where when voltage abnormality or current mutation is detected, the periodic upload task is immediately interrupted to forcibly send an emergency status frame marked with an “urgent” field for prioritized processing by the server.

It should further be noted that a preferred implementation of setting the exception priority upload mechanism specifically includes: configuring an exception judgment logic unit in the information processing unit to periodically collect device operating parameters by invoking acquisition interfaces of current and voltage parameter sensors, and comparing them with set threshold parameters for judgment. The thresholds include preset voltage upper and lower limits, current mutation rate, and load status inconsistency indicators. Voltage and current abnormalities may be evaluated in real time by an A/D conversion module combined with reference power calibration data. When any monitored value exceeds the set threshold, the exception judgment logic triggers an interrupt signal to interrupt the originally scheduled status upload periodic task, and the Microcontroller Unit (MCU) controls a jump to the exception status handling process. In this process, the information processing unit constructs a status data frame with an exception identification field and writes an “urgent” field to distinguish it from regular status packets. It then invokes the communication interface to send an AT+CIPSEND instruction to the SIM communication unit to initiate an aperiodic upload task. After the TCP connection is successfully established, the current status data is immediately sent to the server, and ACK response monitoring is activated. If no confirmation response is received within the set timeout period, the data is cached in a high-priority transmission queue, and a retransmission counter and backoff timing scheduling strategy are enabled. The transmission operation is repeated within the maximum retransmission count to ensure the eventual successful transmission of exception status data.

It should also be noted that executing the received remote control instructions based on the information processing unit and uploading device operating status through the cellular network achieves synchronous closed-loop operation of command response and status perception. The information processing unit invokes LED control drivers according to the command content, including GPIO level setting and PWM duty cycle adjustment, and reads sensor-collected current, voltage, and operating mode parameters in real time to construct standardized status data frames. The upload process is controlled by timed tasks, invoking the AT command interface of the SIM communication module to complete TCP data transmission, while setting an ACK response confirmation mechanism and failure retransmission logic. If the device operation status judgment module detects characteristic indicators such as sudden voltage abnormalities or current mutations, the system immediately interrupts the regular status upload cycle, forcibly generates an emergency status frame marked with “urgent,” and prioritizes its upload to the server through the cellular channel. This step highly integrates control execution and status feedback, featuring a complete control feedback chain, exception response mechanism, and retransmission compensation logic, thereby enabling the device not only to perform functions but also to possess the capabilities of perceiving dynamic operating status, providing feedback, and interacting with the cloud, offering closed-loop monitoring capability of device operation for remote platforms.

Disclosed in the present disclosure is further another embodiment of a remote control method for a fan lamp based on a SIM card. To verify the beneficial effects of the present disclosure, scientific validation is conducted through economic benefit calculation and simulation experiments.

First, three types of fan lamp products are selected for a comparative experiment on remote control performance: fan lamp A of the present disclosure designed with “SIM card communication unit,” commercially available smart lamp B using WiFi communication, and smart lamp C using Bluetooth communication. To ensure consistency in experimental conditions, all devices are installed in a standardized test chamber, with a unified control host sending control instructions and monitoring responses to simulate a terminal remote control environment. The MCU of fan lamp A is integrated into the lamp drive module and connected to the SIM card communication unit via a UART interface. After completing base station registration, the SIM card communication unit establishes a TCP connection and performs processes such as command parsing, light control, status collection, and reporting upon receiving remote instructions. The experiment is conducted in three phases: Phase 1 tests the network initialization time after system startup, recording the time from power-on to successful server handshake, and observing whether heartbeat packets are successfully established. Phase 2 involves sending continuous remote control instructions (e.g., turning lights on/off, dimming) and monitoring communication accuracy metrics such as average response time and command parsing error rate. Phase 3 introduces artificial voltage disturbances or network packet loss environments to observe device exception response behaviors, including abnormal status recognition, data upload delay, interruption of periodic uploads, and triggering of emergency status feedback. All data are recorded by the test host with millisecond-level accuracy. The experiment lasts for 48 hours, and partial experimental data are recorded for reference in Table 1.

TABLE 1
Partial Experimental Data Record

| | Ceiling | Comparative | Comparative |
|---|---|---|---|
| | Lamp A | Lamp B | Lamp C |
| | of Present | (WiFi | (Bluetooth |
| Parameter Name (Unit) | Disclosure | Control) | Control) |
| Average Command Response Time (ms) | 85 | 145 | 102 |
| Status Upload Success Rate (%) | 99.2 | 92.4 | 94.3 |
| Initialization Connection Time (s) | 3.6 | 5.8 | 4.7 |
| Abnormal Status Response Delay (ms) | 210 | 670 | 540 |
| Daily Average Disconnection Count (times) | 0.3 | 1.9 | 0.8 |
| Command Parsing Error Rate (%) | 0.1 | 0.4 | 0.3 |

As evidenced by the data table, the fan lamp utilizing the SIM card-based remote communication architecture of the present disclosure demonstrates significant advantages over traditional WiFi or Bluetooth-controlled smart lamps across multiple key performance indicators. Firstly, in terms of “average command response time”, the lamp according to the present disclosure achieves an average response time of 85 milliseconds, notably superior to the WiFi-controlled lamp's 145 milliseconds and the Bluetooth-controlled lamp's 102 milliseconds. This indicates that the lamp according to the present disclosure may maintain a low-latency communication path with minimal impact from local network fluctuations after base station registration is completed, resulting in stronger stability.

Regarding the “status upload success rate” metric, the lamp according to the present disclosure achieves a success rate of 99.2%, significantly higher than Device B (92.4%) and Device C (94.3%). This demonstrates that during periodic status uploads and abnormal status interrupt uploads, the data upload mechanism and ACK confirmation mechanism of the present disclosure are more reliable, and the retransmission compensation strategy plays a significant role in minimizing upload failures caused by network packet loss.

In terms of “abnormal status response delay”, the lamp according to the present disclosure exhibits a delay of only 210 milliseconds, compared to 670 milliseconds for Device B and 540 milliseconds for Device C. This indicates that through the exception flag triggering logic design in the embedded MCU and the periodic upload interruption mechanism, the system may promptly push data to the server upon detecting status mutations (such as voltage abnormalities or current surges), highlighting the real-time performance advantage of the system in emergency response scenarios.

The “daily average disconnection count” is also a key indicator of system stability. The lamp according to the present disclosure records only 0.3 disconnections per day, significantly lower than the WiFi device (1.9 times) and the Bluetooth device (0.8 times). This is primarily attributed to the cellular module's stronger network retention capability and disconnection reconnection strategy. Furthermore, regarding the “command parsing error rate”, the lamp according to the present disclosure achieves an error rate of only 0.1% by employing frame header verification and CRC check mechanisms, representing an approximately 60% reduction compared to the control devices on average. This demonstrates optimization in data link integrity and communication reliability.

In summary, by introducing a SIM card-based communication mechanism, combined with structurally preset information processing modules, localized anomaly identification, and dual-channel upload strategies, the present disclosure achieves multi-faceted optimization in remote control systems regarding stability, real-time performance, and closed-loop capability. It avoids the instability issues associated with WiFi dependency and Bluetooth short-range communication. The embodiments fully validate the technological innovation and system-level synergy of the present disclosure across multiple key application parameters, demonstrating engineering practicality and differentiated design value.

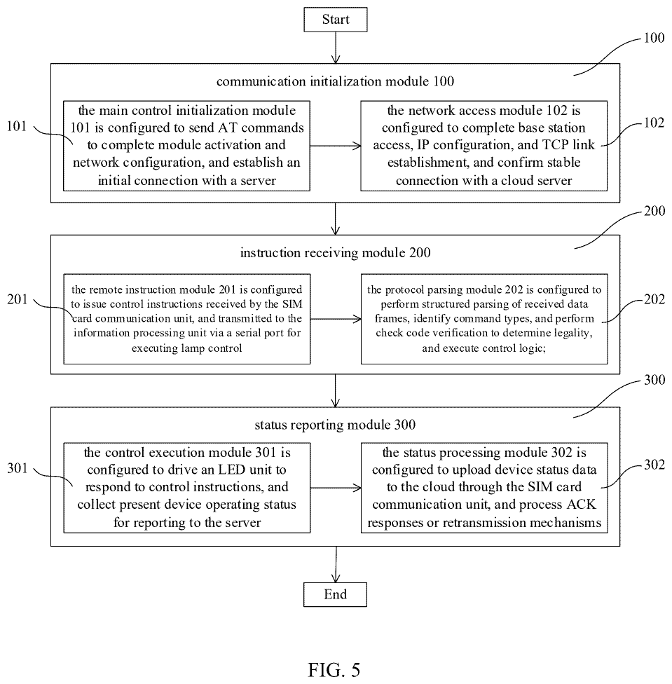

Referring to FIG. 5, disclosed in the present disclosure is further a remote control system for a fan lamp based on a SIM card, including a communication initialization module 100, an instruction receiving module 200, and a status reporting module 300.

The communication initialization module 100 includes a main control initialization module 101 and a network access module 102, where the main control initialization module 101 is configured to automatically initialize the SIM card communication unit through the information processing unit after the fan lamp is powered on, send AT commands to complete module activation and network configuration, and establish an initial connection with a server; the network access module 102 is configured to automatically complete base station access, IP configuration, and TCP link establishment through the SIM card communication unit, and confirm stable connection with a cloud server by periodically sending heartbeat packets.

It should be noted that the communication initialization module 100 operates first during the system startup phase. The main control initialization module 101 activates the information processing unit immediately after the ceiling lamp is powered on, driving the SIM card communication unit to perform initialization operations. This includes sending AT command sets to complete module power-up, SIM card activation, network mode setting, and connection parameter configuration. Subsequently, the network access module 102 takes over the process, responsible for completing operator network access, IP address allocation, and TCP link establishment with the cloud server through the SIM card communication unit. It periodically sends heartbeat packets to maintain connection activity, providing a fundamental channel guarantee for subsequent remote instruction transmission and status feedback.

The main control initialization module 101 within the communication initialization module 100 first drives the information processing unit to initialize the SIM card communication unit after device power-up. This is achieved by sending AT commands to complete module activation and network standard configuration, thereby enabling the underlying hardware channel for subsequent data transmission and reception capabilities. Following this, the network access module 102 automatically completes cellular network access, base station attachment, PDP context activation, and IP address allocation. Under MCU control, it initiates a TCP connection with the remote server and maintains heartbeat communication. Through these operations, the communication initialization module 100 ensures that the instruction reception module 200 may receive control instructions from the server in real time within a stable network environment, providing continuous link support for persistent data monitoring and complete reception. The startup and successful execution of the communication initialization module 100 are prerequisite conditions for the instruction reception module 200 to initiate monitoring logic and receive remote instruction data streams.

The instruction receiving module 200 includes a remote instruction module 201 and a protocol parsing module 202, where the remote instruction module 201 is configured to receive control instructions issued by users through an APP and forwarded by the server through the SIM card communication unit, and transmit the control instructions to the information processing unit via a serial port for executing lamp control; the protocol parsing module 202 is configured to perform structured parsing of received data frames through the information processing unit, identify command types, perform check code verification to determine legality, and execute control logic;

It should be noted that after the device enters the normal operating state, the instruction reception module 200 initiates task monitoring. The remote instruction module 201 continuously monitors control commands delivered from the user-end APP via the server. These commands are transmitted to the SIM communication unit through the cellular network and then forwarded to the information processing unit via the serial port. Subsequently, the protocol parsing module 202 performs structured unpacking of the received data frames, identifies command fields, extracts the payload, and determines the legality of the instructions through CRC verification at the end of the frame before triggering the corresponding control logic.

The instruction reception module 200 receives control instructions forwarded by the server through the remote instruction module 201, and the protocol parsing module 202 parses the data frame structure and determines the legality of the commands. When the instruction type is confirmed (such as turning the light on/off, dimming, etc.), the instruction reception module 200 passes the parsed instruction content to the information processing unit for executing the control logic. Upon receiving the instruction execution signal, the status reporting module 300 activates LED control through the control execution module 301 while simultaneously collecting present status parameters such as voltage, current, and brightness level, providing a complete source of status data for the status processing module 302. Therefore, the instruction reception module 200 logically directly drives the operation of the status reporting module 300 and serves as a prerequisite for the status reporting module 300 to initiate control execution and status collection.

The status reporting module 300 includes a control execution module 301 and a status processing module 302, where the control execution module 301 is configured to drive an LED unit to respond to control instructions based on parsing results through the information processing unit, and collect present device operating status for reporting to the server; the status processing module 302 is configured to upload device status data to the cloud through the SIM card communication unit periodically or upon abnormal triggers, and process ACK responses or retransmission mechanisms.

It should be noted that the control execution module 301 of the status reporting module 300 is responsible for controlling the LED unit to perform specific actions according to the command content after parsing is completed, such as switching, dimming, or timing, while simultaneously collecting key status parameters such as brightness, voltage, and current to generate device status data. The device status data is then encapsulated by the status processing module 302 into standard JSON format and sent to the server through the SIM card communication unit. If the data upload is successful, the system receives an ACK response; if the server does not respond, a retransmission mechanism is triggered based on the number of retries and the time window. If abnormal parameters such as voltage irregularities or current surges are detected, the status processing module 302 interrupts the periodic upload and immediately initiates an abnormal priority upload path, generating an urgent status frame and performing rapid reporting.

The status reporting module 300 relies on the cellular network registration and server TCP connection established by the communication initialization module 100 to complete the reporting of device status data. The main control initialization module 101 and the network access module 102 within the communication initialization module 100 first complete SIM card activation, base station access, IP configuration, and heartbeat mechanism establishment after system power-up, forming a stable data channel. Only on this basis may the status processing module 302 implement periodically or exception-triggered data upload tasks. If the communication link is disconnected, the status reporting function will trigger reconnection and retransmission mechanisms. Therefore, the status reporting module 300 and the communication initialization module 100 operate in close coordination, with the former completing data feedback and the latter providing basic communication support.

The aforementioned functions, if implemented in the form of software functional units and sold or used as independent products, may be stored in a non-transitory computer-readable storage medium. Based on such understanding, the technical solution of the present disclosure may be embodied, in whole or in part, as a software product in its essential form or in aspects contributing to the prior art. This computer software product is stored in a non-transitory computer-readable storage medium and includes several instructions configured to enable a computer device (which may be a personal computer, server, or network device, etc.) to execute all or part of the steps of the methods described in various embodiments of the present disclosure. The aforementioned non-transitory computer-readable storage medium includes various media capable of storing program codes, such as USB drives, portable hard drives, read-only memory (ROM), random access memory (RAM), magnetic disks, or optical disks.

The logic and/or steps represented in flowcharts or otherwise described herein may be considered as ordered lists of executable instructions for implementing logical functions. These may be embodied in any non-transitory computer-readable medium for use by, or in connection with, an instruction execution system, apparatus, or device (such as a computer-based system, a processor-based system, or other system that may retrieve instructions from an instruction execution system, apparatus, or device and execute the instructions). For the purposes of this specification, a “non-transitory computer-readable medium” may be any apparatus that may contain, store, communicate, propagate, or transport a program for use by, or in connection with, an instruction execution system, apparatus, or device.

More specific examples (non-exhaustive list) of non-transitory computer-readable media include the following: electrical connections with one or more wires (electronic devices), portable computer disk cartridges (magnetic devices), random access memory (RAM), read-only memory (ROM), erasable programmable read-only memory (EPROM or flash memory), fiber optic devices, and portable compact disc read-only memory (CDROM). Furthermore, a non-transitory computer-readable medium may even be paper or another suitable medium on which the program may be printed, as the program may be electronically obtained, for example, by optically scanning the paper or other medium, followed by editing, interpretation, or, if necessary, other suitable processing, and then stored in a computer memory.

It should be understood that various parts of the present disclosure may be implemented in hardware, software, firmware, or a combination thereof. In the aforementioned embodiments, multiple steps or methods may be implemented using software or firmware stored in a memory and executed by a suitable instruction execution system. For example, if implemented in hardware, as in another embodiment, the invention may be implemented using any one or a combination of the following techniques well-known in the art: discrete logic circuits with logic gate circuits for implementing logical functions on data signals, application-specific integrated circuits (ASICs) with suitable combinational logic gate circuits, programmable gate arrays (PGAs), field programmable gate arrays (FPGAs), and the like. It should be noted that the above embodiments are merely intended to illustrate the technical solutions of the present disclosure rather than to limit them. Although the present disclosure has been described in detail with reference to preferred embodiments, those skilled in the art should understand that modifications or equivalent replacements to the technical solutions of the present disclosure may be made without departing from the spirit and scope of the technical solutions of the present disclosure. All such modifications and equivalent replacements shall fall within the scope of the claims of the present disclosure.

What is claimed is:

1. An intelligent fan lamp, comprising a base configured to be mounted on a wall, fan blades arranged at a bottom of the base, and a drive motor arranged in the base and configured to drive the fan blades to rotate, a fixed seat connected to a bottom of the base and located below the fan blades; wherein
the fixed seat is provided with a voice interaction device configured for voice interaction, a control module electrically connected to the drive motor and the voice interaction device, a light strip electrically connected to the control module, and a lampshade configured to cover the light strip; the control module comprises a subscriber identity module (SIM) card slot and a card slot provided on the SIM card slot, the card slot is configured to insert a subscriber identity module (SIM) card for network connection.

2. The intelligent fan lamp according to claim 1, wherein the voice interaction device comprises a housing provided on the fixed seat, a microphone arranged in the housing and configured to receive voice commands, and a speaker arranged in the housing and configured to output voice commands; the housing comprises a main body fixed to the fixed seat and a cover detachably assembled at a bottom of the main body; the cover is provided with a plurality of first through holes communicating with the microphone and a plurality of second through holes communicating with the speaker.

3. The intelligent fan lamp according to claim 1, wherein the voice interaction device is arranged at a center of the fixed seat, the light strip is in an annular shape, and the light strip is arranged surrounding the voice interaction device; an opening is provided on the lampshade for the voice interaction device to pass through, and the lampshade is connected to the fixed seat by threaded connection.

4. The intelligent fan lamp according to claim 3, wherein the drive motor comprises a motor shaft fixed to the base by threaded connection, and a rotor portion rotatably arranged on the motor shaft, wherein the fan blades are fixed to the rotor portion; a lower end of the motor shaft extends beyond the bottom of the base, a connecting plate is sleeved on the lower end of the motor shaft, a locking nut configured to lock and fix the connecting plate is provided on the lower end of the motor shaft, and the fixed seat is fixed to the connecting plate.

5. The intelligent fan lamp according to claim 2, wherein the control module comprises a circuit board arranged in the housing, and a control chip arranged on the circuit board, wherein the SIM card slot is arranged on the circuit board.

6. The intelligent fan lamp according to claim 1, further comprising a remote communication module configured to receive input information from the control module, wherein the remote communication module integrates blockchain node functionality and is configured to encrypt user voice commands and transmit the input information to an Artificial Intelligence (AI) large model system through a wireless network; the AI large model system comprises distributed Artificial Intelligence (AI) nodes, wherein each node collaboratively processes voice commands through smart contracts and generates return results; the return results comprise lamp control commands and intelligent service recommendations related to user context;
wherein the control module is provided with an edge computing unit configured to perform lightweight semantic parsing locally and dynamically allocate tasks with the distributed AI nodes.

7. The intelligent fan lamp according to claim 6, wherein the control module further comprises a prompt word rule database configured to pre-obtain prompt word rules of the AI large model system, determine whether modification of input information is required based on the prompt word rules, and modify the input information based on the prompt word rules to generate modified input information when the control module determines that modification of the input information is required;
the prompt word rule database comprises context-aware templates and user behavior profiles, and the control module generates modified input information through the following methods:
(a) extracting spatiotemporal characteristic parameters from voice commands, including present time, ambient light intensity, and mechanical structure position status;
(b) calculating context weight coefficients in combination with user historical operation records;
(c) matching an optimal prompt word framework from a template library according to the weight coefficients; and
(d) embedding original voice commands into the framework to generate structured query statements;
wherein the distributed AI nodes invoke a multimodal large model to generate responses according to the structured query statements.

8. The intelligent fan lamp according to claim 6, wherein the control module is further configured to determine whether explanatory information is required to be added to return results after obtaining the return results from the AI large model system, generate explanatory information by invoking an explanatory information generation module based on preset preference information of lamp users after determining that explanatory information is required to be added to the return results, and add the explanatory information to the return results to generate modified return results;
the explanatory information generation module comprises:
a credibility assessment unit, configured to calculate confidence scores based on feature vectors of return results from the AI large model system; and
a personalized adaptation unit, configured to invoke a user preference model in a storage module, wherein the user preference model is continuously updated through federated learning; when the confidence score is lower than a threshold, the personalized adaptation unit automatically appends alternative solution descriptions and verification requests;
wherein the explanatory information is output in the form of interactive voice segments, supporting users to provide feedback and corrections through natural language.

9. The intelligent fan lamp according to claim 6, wherein the lamp further comprises a storage module configured to store user preference information;
the storage module comprises:
a privacy protection partition, configured to store user biometric data using homomorphic encryption technology;
an interactive memory unit, configured to record a triplet relationship graph of device status-voice command-user feedback; and
a model cache area, configured to store lightweight inference models delivered by the AI large model system, supporting maintenance of basic intelligent services during network interruption,
wherein the control module automatically optimizes a local decision tree based on data from the memory unit to achieve intention prediction in an offline state.

10. A method for remote control of a fan lamp based on a subscriber identity module (SIM) card, applied to the fan lamp according to claim 6, comprising:
initializing a subscriber identity module (SIM) card communication unit through a preset information processing unit, and connecting cellular network registration with a server;
receiving remote control instructions through the SIM card communication unit, and transmitting the remote control instructions to the information processing unit for parsing;
executing received remote control instructions based on the information processing unit, and uploading device operating status through the cellular network;
wherein initializing the SIM card communication unit comprises integrating an embedded microcontroller into a drive module, connecting to the SIM card communication unit through UART, wherein the communication unit comprises an FPC antenna and power management, the embedded microcontroller is configured with a serial port buffer and an exception interrupt mechanism to construct a complete device initialization and communication infrastructure;
wherein receiving remote control instructions through the SIM card communication unit comprises transmitting the remote control instructions encapsulated by the server to the SIM card communication unit, and outputting the remote control instructions by the SIM card communication unit to the information processing unit through a serial port;
wherein uploading device operating status through the cellular network comprises periodically reading the cache by the information processing unit and uploading the status through the SIM card communication unit, and interrupting the process to construct and send a marked status frame when the status is abnormal.

11. The method for remote control of a fan lamp based on a SIM card according to claim 10, wherein the initializing the SIM card communication unit comprises:
employing an embedded microcontroller as a core control chip by the information processing unit after the fan lamp is powered on and started upon connection to a power supply; integrating the microcontroller inside a ceiling lamp power drive module; connecting to the SIM card communication unit through a standard Universal Asynchronous Receiver/Transmitter (UART) interface, wherein the SIM card communication unit comprises a subscriber identity module (SIM) card slot, a power management unit, and a radio frequency antenna interface; encapsulating the SIM card communication unit on a communication area of a circuit board; leading out antenna layout to an edge of a plastic lamp cover through a flexible printed circuit (FPC) board; connecting LED light-emitting units to the embedded microcontroller through Pulse Width Modulation (PWM) control lines and switch signal lines; positioning an LED drive circuit on a main control power module; establishing communication connection between the LED drive circuit and the embedded Microcontroller Unit (MCU) in the information processing unit through a bus; arranging the LED drive circuit in a middle portion of the lamp body; providing power supply between various components by a unified Direct Current (DC) power source; distributing power through motherboard power cables; supporting input voltage detection; connecting the voltage detection to an Analog-to-Digital Conversion (ADC) interface of the embedded microcontroller; configuring a serial port buffer management mechanism in firmware of the embedded microcontroller; handling transceiving processes of serial port input data frames and output status frames; and setting an exception flag to trigger emergency communication path interruption and status retransmission.

12. The method for remote control of a fan lamp based on a SIM card according to claim 10, wherein the connecting cellular network registration with a server comprises:
accessing a network through a built-in radio frequency device by the SIM card communication unit automatically; maintaining a communication heartbeat connection with the server;
searching for and accessing a network automatically after the cellular unit completes SIM card activation; performing frequency scanning by an internal scheduling mechanism of the cellular unit according to a preset priority operator frequency band table in memory; selecting a base station with optimal signal quality for access; completing an Attach process;
configuring an IP address based on PDP (Packet Data Protocol) context activation after successful network registration; initiating a TCP (Transmission Control Protocol) connection with a designated server through an AT+CIPSTART command driven by instructions from the embedded microcontroller; setting a heartbeat packet transmission interval threshold after successful connection; returning an ACK (Acknowledge character) response packet by the server upon receiving the heartbeat packet; confirming effective communication;
entering a disconnection reconnection state by the embedded microcontroller automatically if no heartbeat response is received within a set transmission count threshold; and recording the reason for disconnection.

13. The method for remote control of a fan lamp based on a SIM card according to claim 10, wherein the receiving remote control instructions through the SIM card communication unit comprises:
initiating, by terminal users, lighting control commands through an APP (Application) platform and uploading the lighting control commands to a server; forwarding, by the server, the lighting control commands to the SIM card communication unit through the cellular network; initiating control commands in the interface comprises turning lights on/off, dimming, timing, and status query;
encapsulating the control commands in JSON (JavaScript Object Notation) format and uploading the control commands to a cloud server API (Application Programming Interface) interface through the HTTPS (HyperText Transfer Protocol Secure) protocol; performing identity authentication and data parsing by the server; delivering the control commands to the IP address and port of the SIM card communication unit bound to the corresponding device through a Socket connection;
monitoring server data by the SIM card communication unit continuously while maintaining a TCP (Transmission Control Protocol) connection state; outputting complete control instructions to the information processing unit through a serial port after receiving control data frames;
performing logical verification on the complete control instructions by the information processing unit; triggering corresponding control processes comprising turning on LEDs and adjusting PWM signals.

14. The method for remote control of a fan lamp based on a SIM card according to claim 10, wherein the parsing comprises:
outputting complete data frames received from the server to a UART interface of a main control embedded microcontroller by the SIM card communication unit; reading the serial port buffer in real time by a serial port monitoring program running in the embedded microcontroller; parsing frame headers, frame bodies, and check bits according to a control protocol structure; forming control protocol frames of fixed-length or variable-length formats comprising frame headers, command identifiers, payloads, and check codes; determining by the embedded microcontroller that the command identifier field is LAMP_CTRL and the payload field is an ON or OFF command; performing check code verification; invoking lighting control function interfaces according to corresponding control logic processes after successful verification; recording an exception log and ignoring the present command by the embedded microcontroller if check code verification fails or the command is illegal.

15. The method for remote control of a fan lamp based on a SIM card according to claim 14, wherein the executing the received remote control instructions based on the information processing unit comprises:
executing control commands by the embedded microcontroller invoking a driver layer interface according to command content to control an LED status, wherein the LED status comprises setting General Purpose Input Output (GPIO) high and low levels to control switching, and adjusting brightness levels through a PWM unit;
invoking a sensor module interface by the embedded microcontroller to read lamp operating status information, wherein the lamp operating status information comprises a present brightness level, a current value, a voltage value, and an operating mode; constructing a status data packet; caching the constructed status data packet in a communication buffer for uploading;
generating a status code and encapsulating the status code into a status response frame by the embedded microcontroller if command execution fails or feedback is abnormal.

16. The method for remote control of a fan lamp based on a SIM card according to claim 10, wherein the uploading device operating status through the cellular network comprises:
setting a status data upload period by the information processing unit; invoking a communication interface by a timed task to read a latest constructed status packet from a status cache queue; formatting the status packet into a JSON string; sending an AT+CIPSEND command to the SIM card communication unit to initiate a TCP data transmission process; waiting for the server to return an ACK response packet by the SIM card communication unit after transmission completion; confirming successful reception; pushing present data back into a transmission queue by the embedded microcontroller if no response is received within a set time threshold; initiating a backoff retransmission mechanism; setting an exception priority upload mechanism; interrupting periodic upload tasks immediately when detecting voltage abnormality or current mutation; sending an emergency status frame forcibly; and marking the frame with an urgent field for prioritized processing by the server.

17. A remote control system for a fan lamp based on a subscriber identity module (SIM) card, comprising a communication initialization module, an instruction receiving module, and a status reporting module;
the communication initialization module comprises a main control initialization module and a network access module, wherein the main control initialization module is configured to automatically initialize the subscriber identity module (SIM) card communication unit through the information processing unit after the fan lamp is powered on, send AT commands to complete module activation and network configuration, and establish an initial connection with a server; the network access module is configured to automatically complete base station access, IP configuration, and TCP (Transmission Control Protocol) link establishment through the SIM card communication unit, and confirm stable connection with a cloud server by periodically sending heartbeat packets;
the instruction receiving module comprises a remote instruction module and a protocol parsing module, wherein the remote instruction module is configured to receive control instructions issued by users through an APP (Application) and forwarded by the server through the SIM card communication unit, and transmit the control instructions to the information processing unit via a serial port for executing lamp control; the protocol parsing module is configured to perform structured parsing of received data frames through the information processing unit, identify command types, perform check code verification to determine legality, and execute control logic;
the status reporting module comprises a control execution module and a status processing module, wherein the control execution module is configured to drive an LED unit to respond to control instructions based on parsing results through the information processing unit, and collect present device operating status for reporting to the server; the status processing module is configured to upload device status data to the cloud through the SIM card communication unit periodically or upon abnormal triggers, and process ACK (Acknowledgement character) responses or retransmission mechanisms.
